(19) United States
(12) Patent Application Publication
(10) Pub. No.: US 2026/0174073 A1
(43) Pub. Date: Jun. 25, 2026

(54) GENERATING AND APPLYING STEAM TO SOIL

(71) Applicant: High Degree, Inc., Palo Alto, CA (US)

(72) Inventors: Austin Bowie, San Francisco, CA (US); Steven Alan Fennimore, Salinas, CA (US)

(73) Assignee: High Degree, Inc., Palo Alto, CA (US)

(21) Appl. No.: 19/428,614

(22) Filed: Dec. 22, 2025

Related U.S. Application Data
(60) Provisional application No. 63/737,736, filed on Dec. 22, 2024.

(51) Int. Cl. A01M 21/04; A01M 17/00

(52) U.S. Cl. CPC A01M 21/04; A01M 17/002

(57) ABSTRACT

Devices and methods for inserting steam into agricultural soil via probes, bars and otherwise are disclosed. These are rotated and dragged through the soil. Bed shapers in conjunction with that are disclosed.

### CROSS-REFERENCE TO RELATED APPLICATION

This application claims the benefit of US Provisional Application No. 63/737,736 filed Dec. 22, 2024, which is hereby incorporated by reference.

### BACKGROUND OF THE INVENTION

The present invention pertains to agriculture, and more specifically to using steam for weed and/or fungus and/or pest management. Thus, there is a need for improvement in this field.

### SUMMARY OF THE INVENTION

The present invention involves using systems and methods for using steam in agricultural applications, both alone and in combination with bed formation.

Further forms, objects, features, aspects, benefits, advantages, and embodiments of the present invention will become apparent from a detailed description and drawings provided herewith.

### BRIEF DESCRIPTION OF THE DRAWINGS

FIG. 1A is a perspective view of a first embodiment in a field.

FIG. 1B is a perspective view of a device in isolation.

FIG. 2A is a perspective view of a second embodiment in a field.

FIG. 2B is a perspective view of a second embodiment in isolation.

FIG. 3A side elevation of a third embodiment.

FIG. 3B is side elevation of a third embodiment, partially cutaway.

FIG. 3C rear elevation view of FIG. 3A.

FIG. 4 side elevation of a fourth embodiment.

FIGS. 5A-5C are views of a fifth embodiment.

FIGS. 6A-6D (including FIG. 6D.1-6D.4) are views of a sixth embodiment.

FIG. 7A is a top plan cross-sectional view along cut B-B of FIG. 7B.

FIG. 7B is a side elevation view of a seventh embodiment.

FIG. 7C.1 is a perspective detail and FIG. 7C.2 is a plan view detail of one example of a valving mechanism of the device of FIG. 7A.

FIG. 7D.1 is a perspective detail and FIG. 7D.2 is a plan view detail of one example of a valving mechanism of the device of FIG. 7A.

FIGS. 8A-8E are views of an eight embodiment.

FIG. 9A-9D are views of a ninth embodiment.

FIG. 9E.1 is a rear partially cutaway view of the ninth embodiment with an optional bed shaper added.

FIG. 9E.2 is a side partial cutaway view along cut G-G of FIG. 79E.1.

FIGS. 10A-10C are views of a tenth embodiment.

### DESCRIPTION OF THE INVENTION

For the purpose of promoting an understanding of the principles of the invention, reference will now be made to the embodiments and methods illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

With respect to the specification and claims, it should be noted that the singular forms “a”, “an”, “the”, and the like include plural referents unless expressly discussed otherwise. As an illustration, references to “a device” or “the device” include one or more of such devices and equivalents thereof. It also should be noted that directional terms, such as “up”, “down”, “top”, “bottom”, and the like, are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

As shown in the Figures and defined in the definitions, we provide several devices 100, 100a, 200, 300, 400, 500, 600, 700, 800, 900, 1000 and methods for preparing agricultural planting beds, see e.g. B1 and B2. This may include a bed shaper 270, 271, 370, comprising a left surface 273, 373, 973, 1073, a right surface 272, 372, 972, 1072 and a top surface 274, 374, 974, 1074 inboard of the left and right surfaces and collectively defining a rear-elevation profile adapted for shaping a soil bed above and between furrows F outside the left and right surfaces as the bed shaper is advanced in a soil field a first direction.

These may include or be connectable to a steam delivery system adapted to be connected to a steam source (see e.g. 150, 260, 360, 460). The steam delivery system comprising one or more conduits 103, 203, 303, 403, 503, 504a, 504b, 603, 604, 604 b, 703, 704, 704 a, 704 b, 803, 804, 804 a, 805, 904,904a, 906, 1003, 1004, 1004a, 1007, 1074 to deliver steam from the steam source to a plurality of steam exit openings.

These steam exit openings may be positioned below the soil surface SS or 55 for steam delivery into the soil. The steam exit openings preferably are positioned above, ahead of, or both above and ahead of the bed shaper.

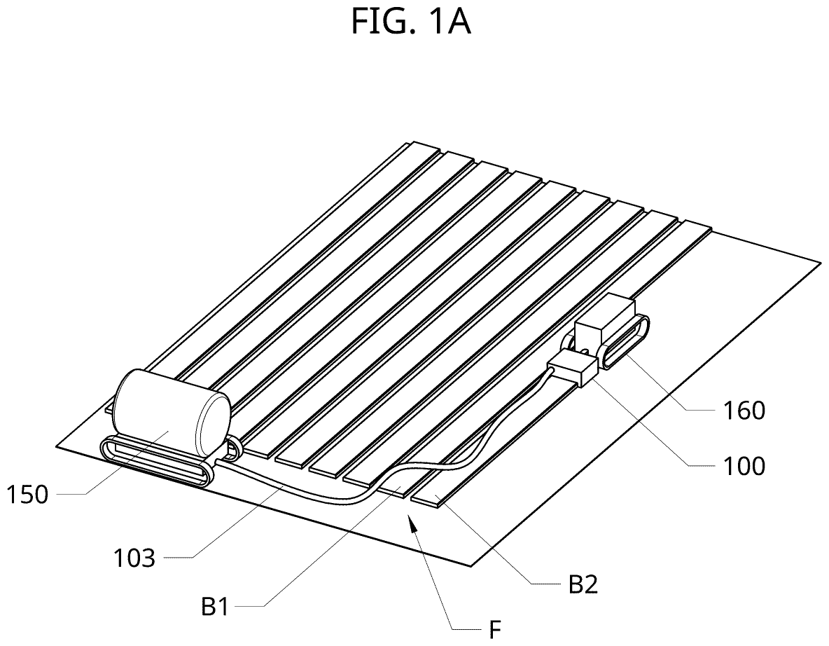

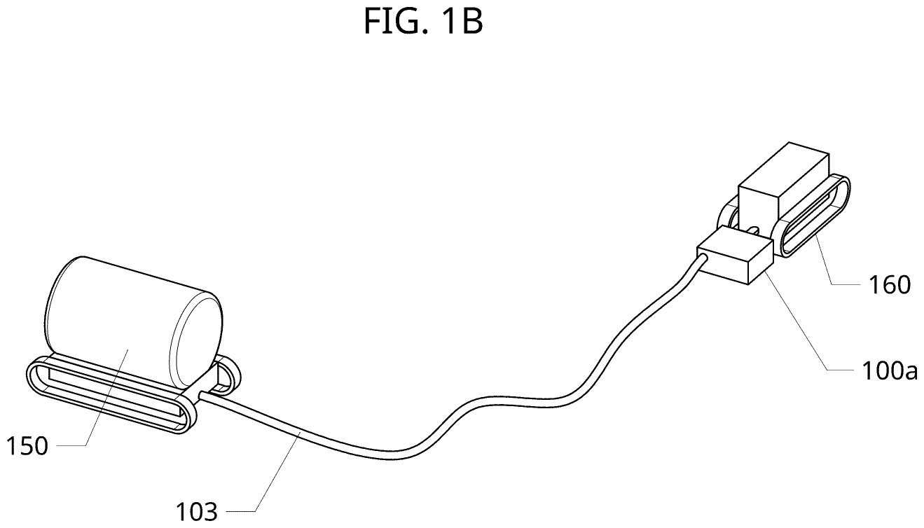

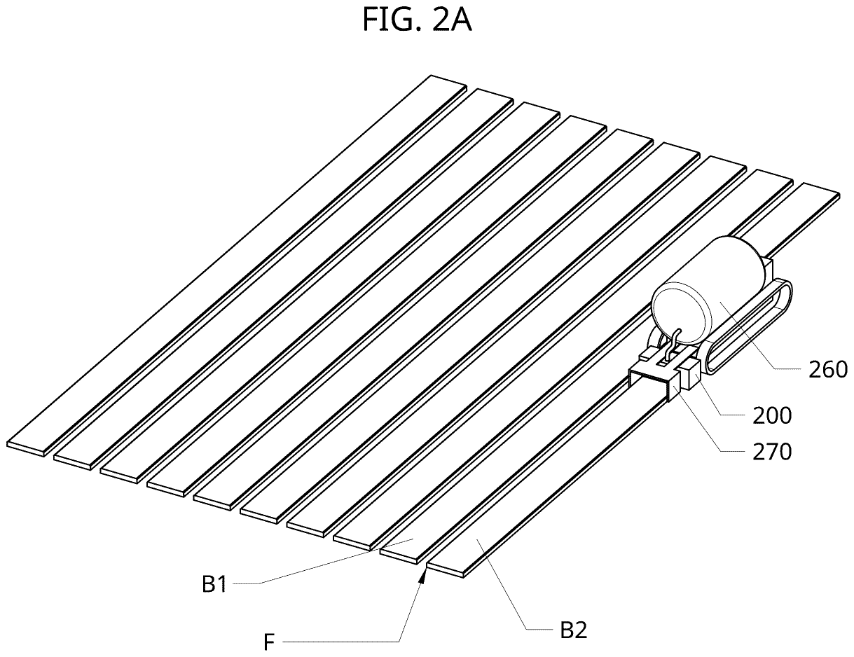

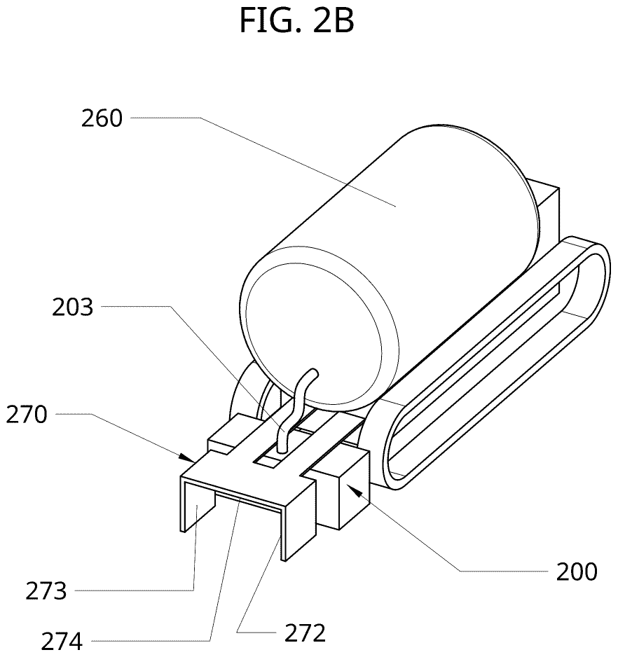

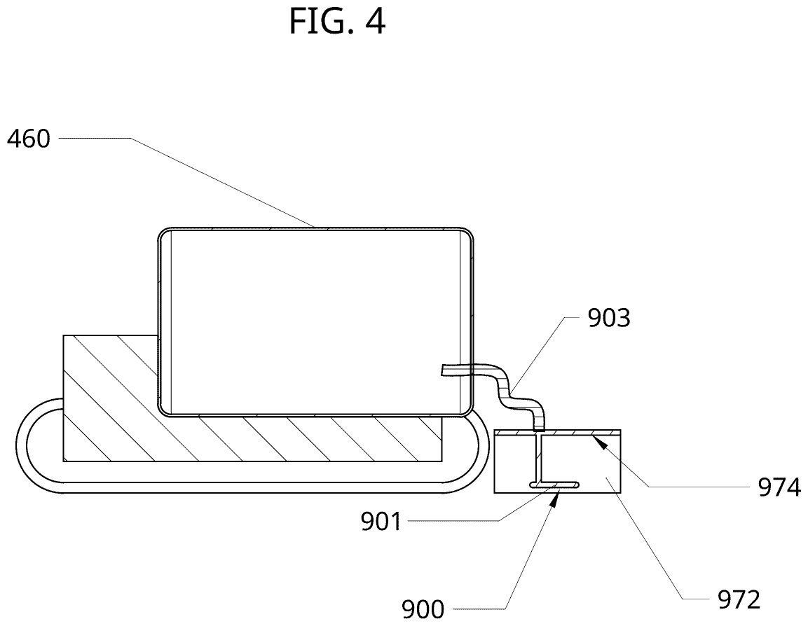

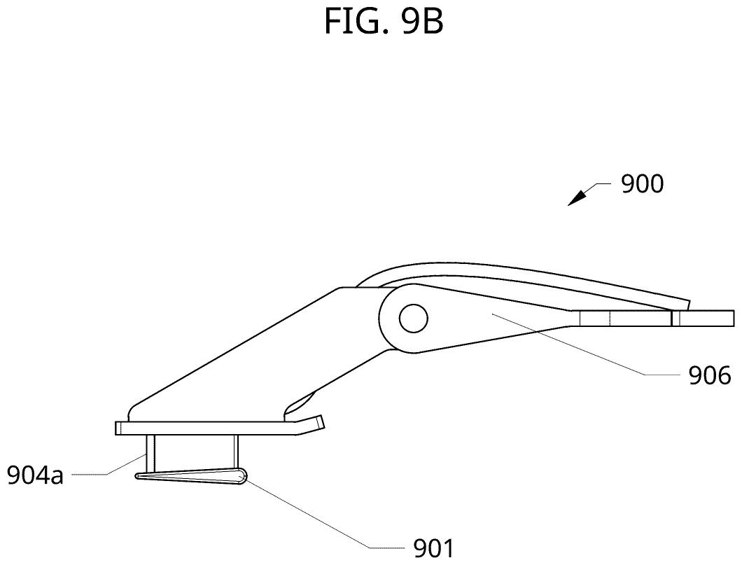

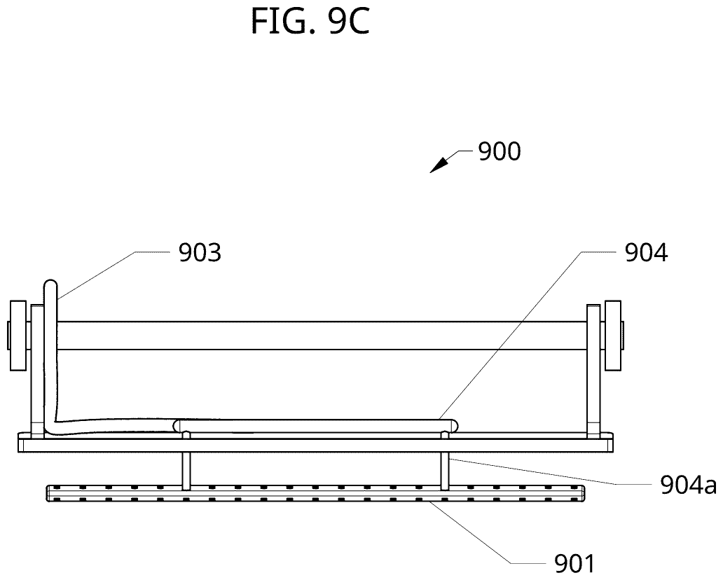

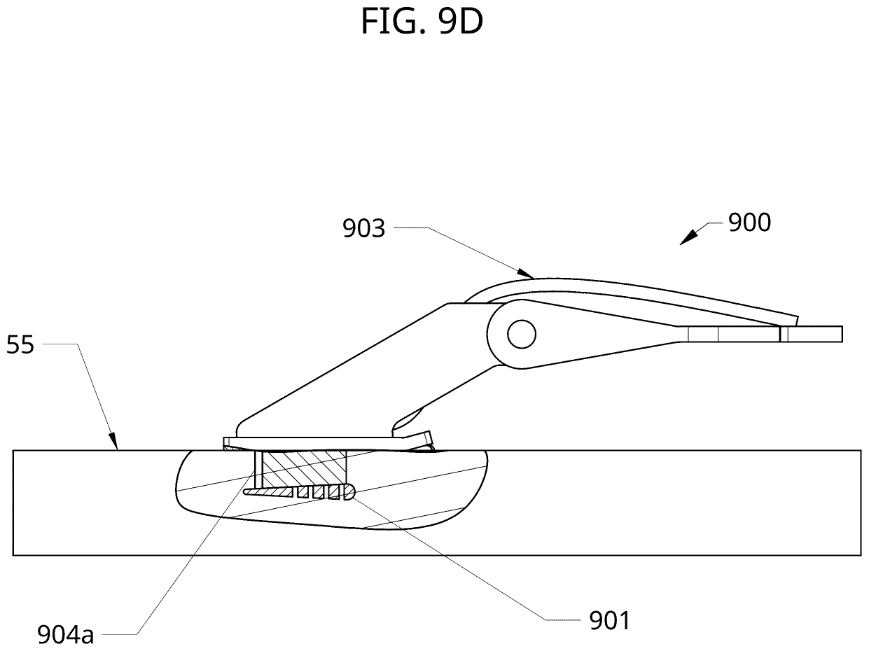

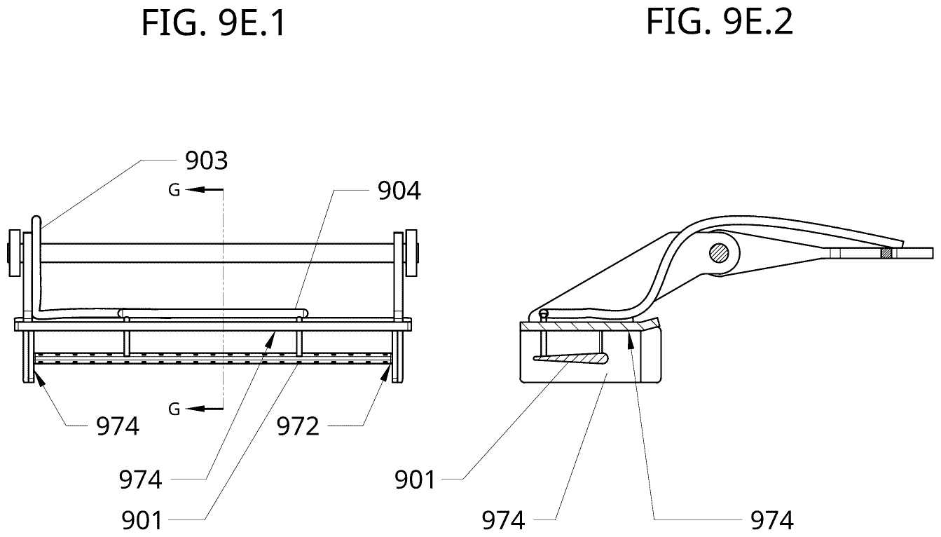

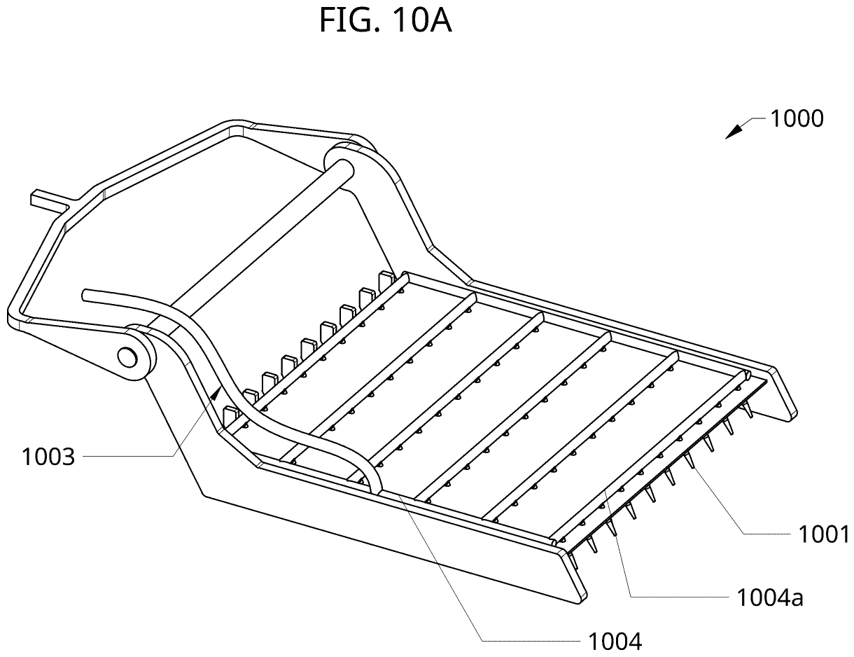

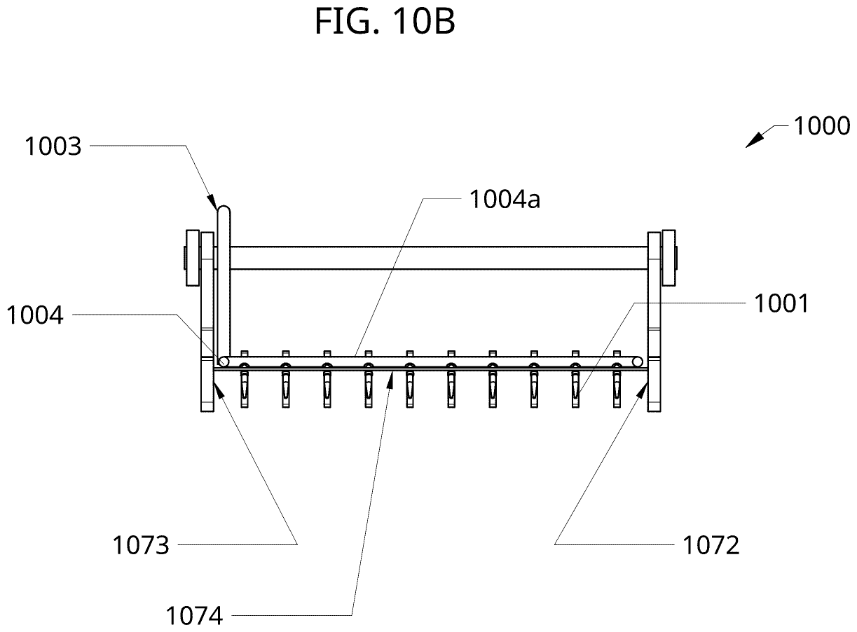

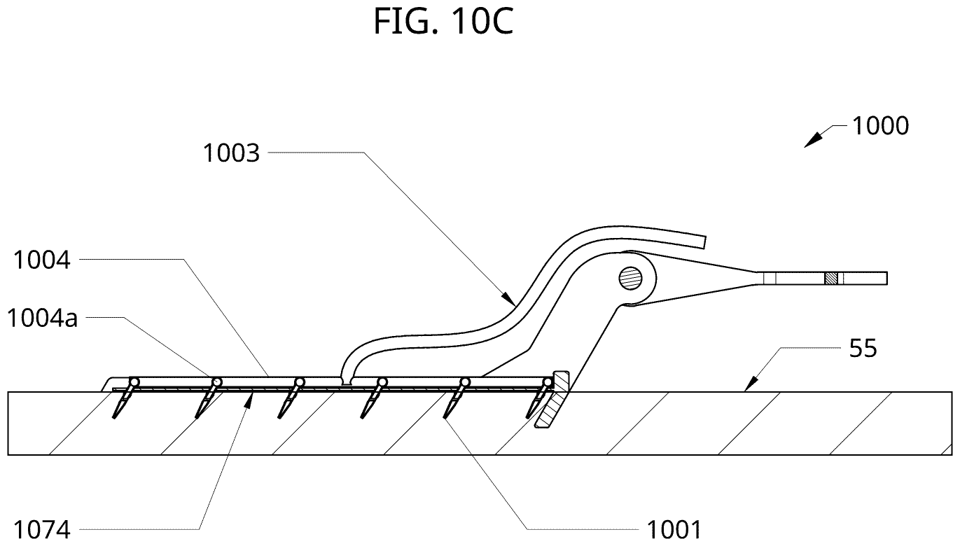

Optionally, the device may be a hollow rod or bar 901 (see FIGS. 4, 9A-9D, 9E.1 and 9E.2) dragged below the soil and within and/or ahead of the bed shaper, if any. See also FIGS. 1A, 1B, 2A and 2B as examples. Optionally, the device may be probes 1001 (see FIGS. 10A-10C) dragged below the soil and within and/or ahead of the bed shaper.

Or optionally the device may include a plurality of probes 501, 601, 701, 801, 1001 having the steam exit openings inserted below the soil surface SS or 55.

Optionally the steaming device may be without a bed shaper, or with only a partial bed shaper, such as one example, a top surface 974 bed shaper shown in FIGS. 9A-9E.2. Optionally before planting, steaming can be done first, followed by a separate bed shaper, or in the reverse of that.

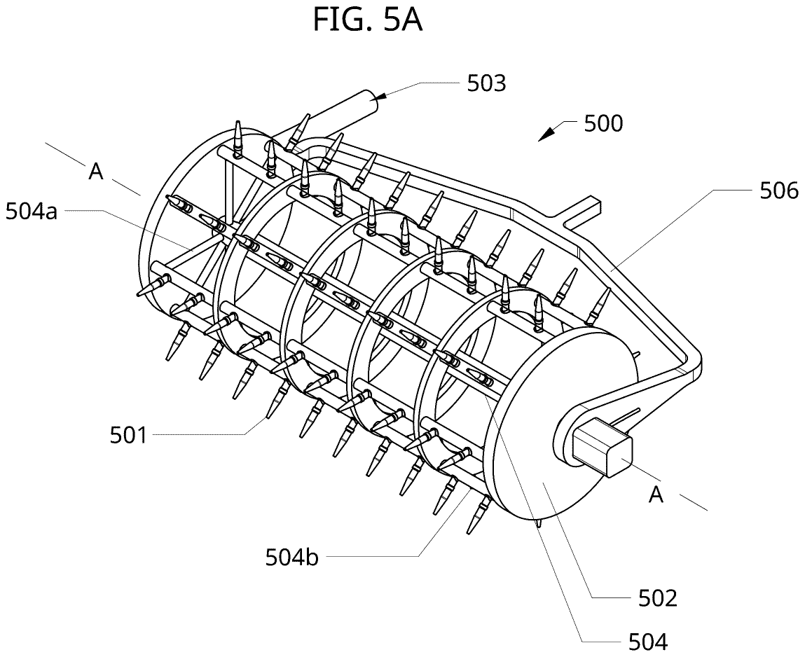

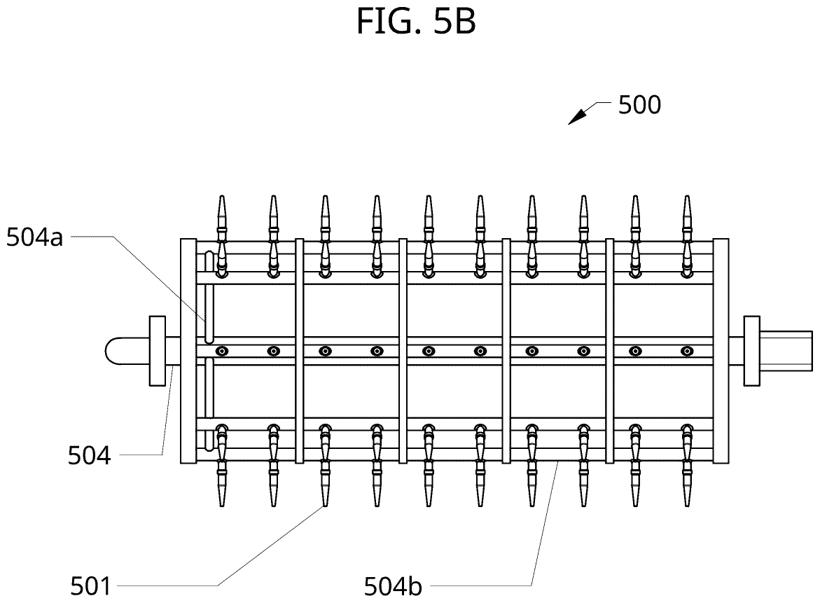

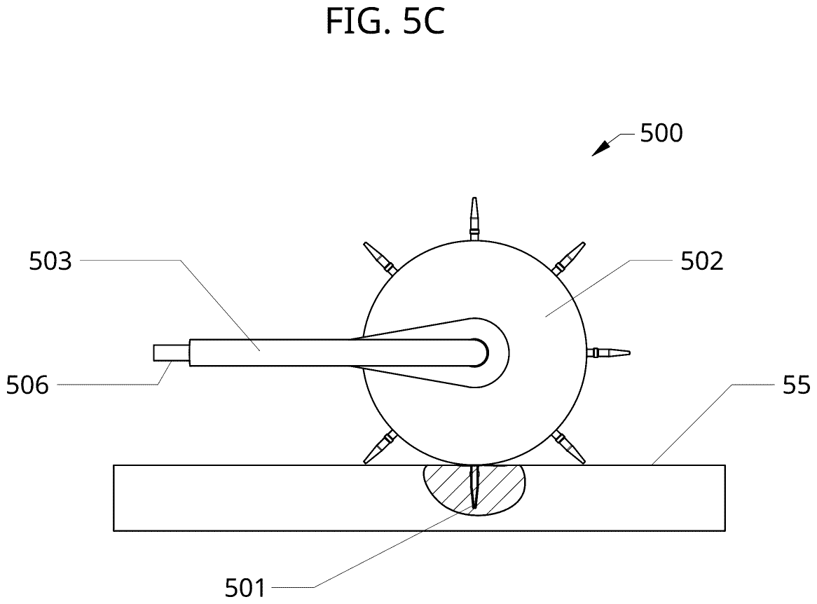

Optionally, the device may further include one or more rotary member 502, 604, 702, 802 rotating about a first axis (see e.g. 504, axis A-A in FIGS. 5A, 712 (rotating coupler), 804), of rotation that is generally horizontal and generally perpendicular to the first direction, the rotary member causing probes 501, having the steam exit openings to repetitively inject into the soil and then out of the soil as the device advances in the first direction.

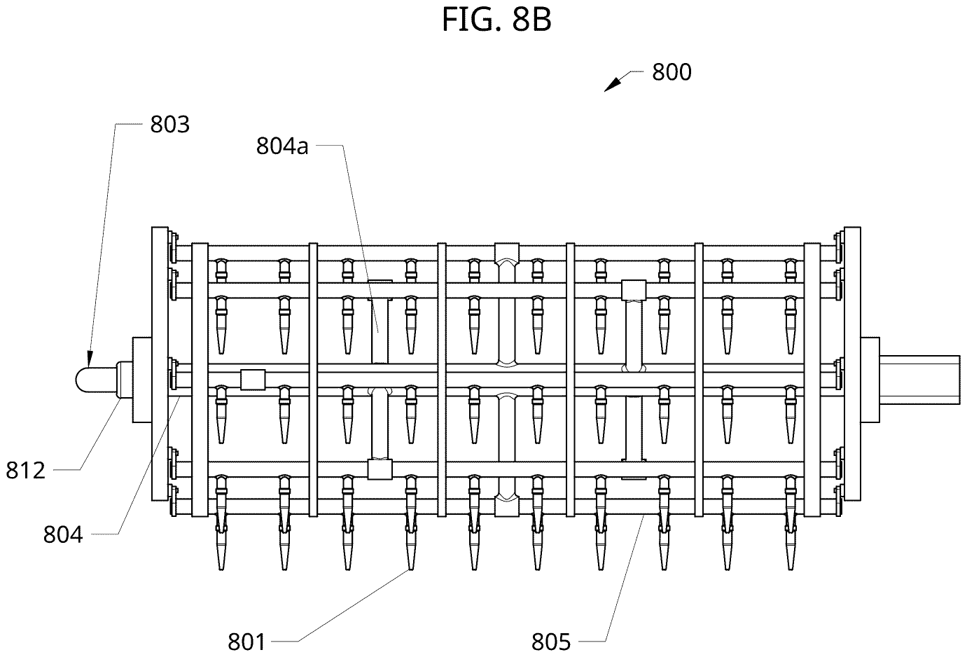

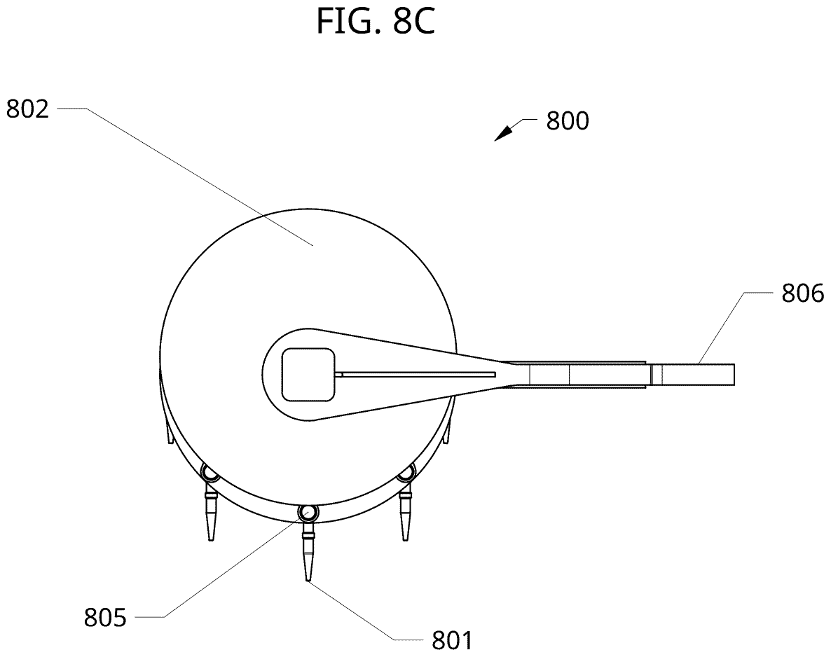

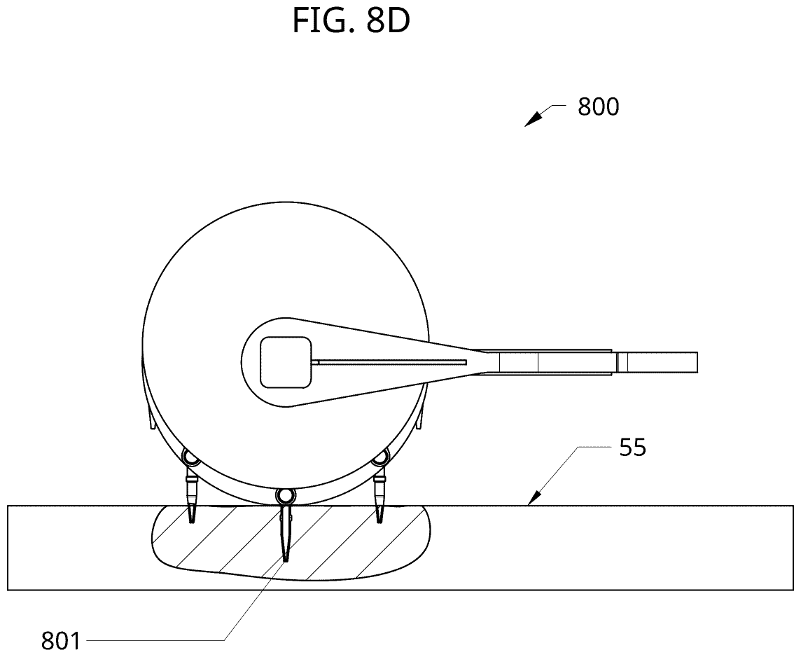

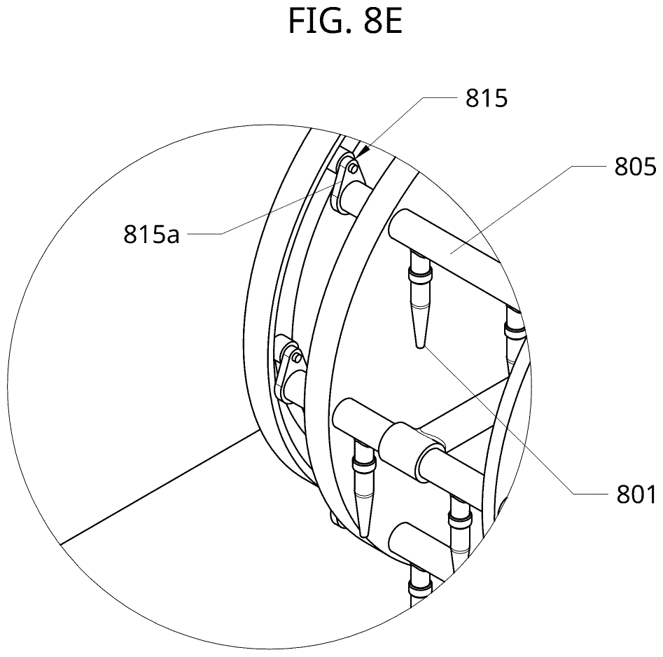

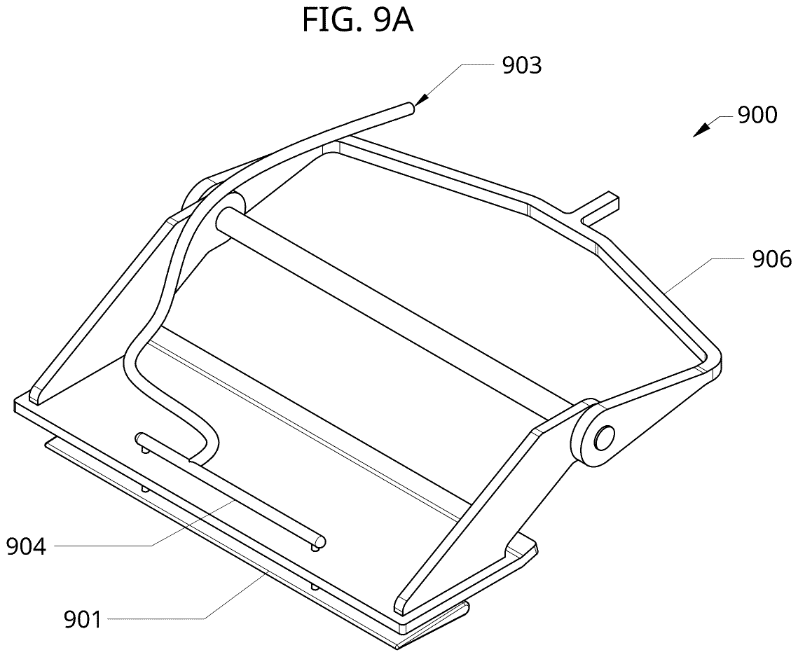

Optionally, probes, (e.g. 501), when used, may be fixed and permanently radiate out around 502 as exemplified in FIG. 5A. Alternatively, probes, (e.g. 801), when used, may be movable. For one example, with reference to FIGS. 8A-8E, a cam follower mechanism may be used to keep the probes downward facing, even perpendicular to the ground, as shown in FIG. 8E. The cam mechanism 815, 815a shown there rotate rod and conduit 805 with its attached probe 801 maintained downwardly facing.

Optionally, valving is provided to open and close to confine steam flow to only the lower probes in the soil to reduce or block wasting steam flow out of the probes in the atmosphere above the soil surface.

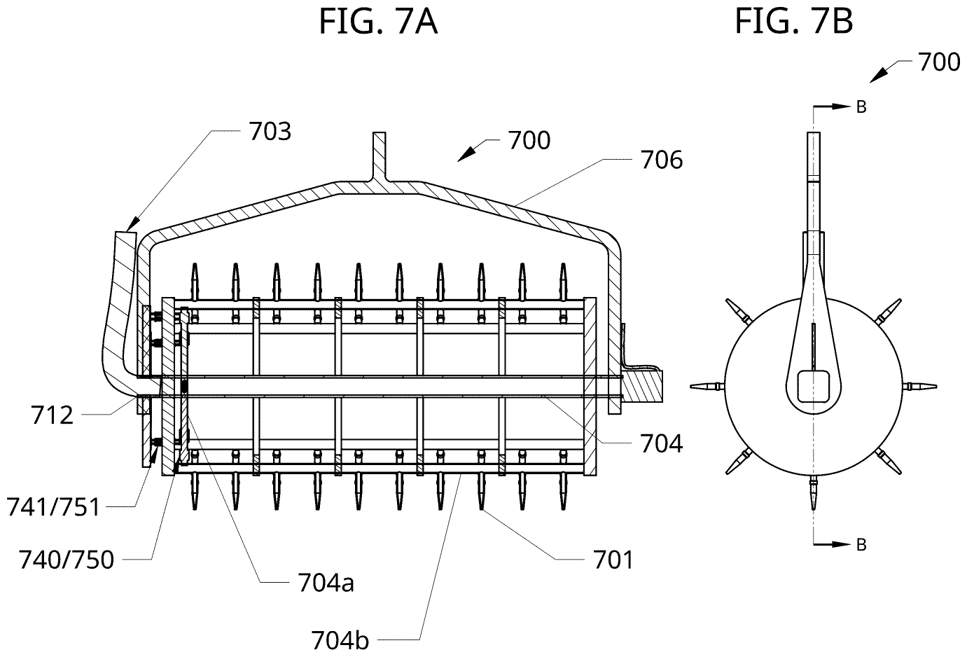

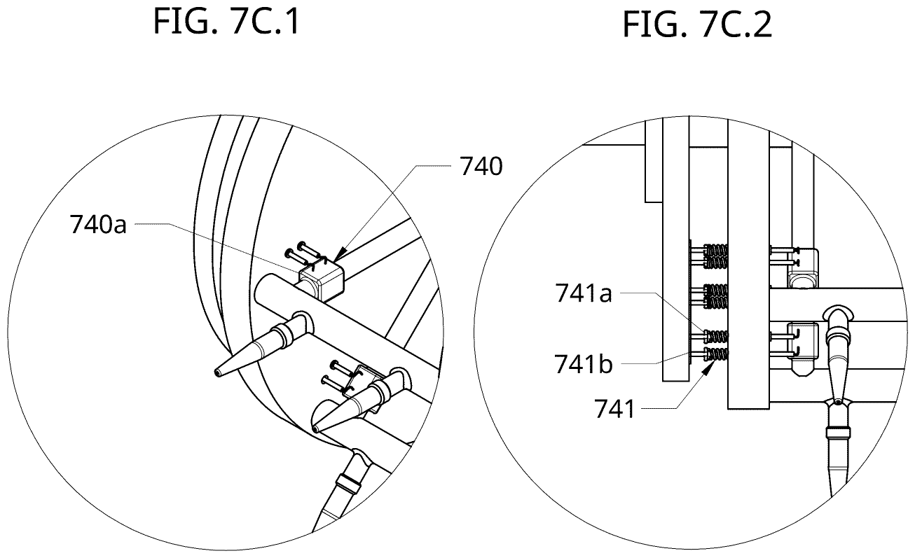

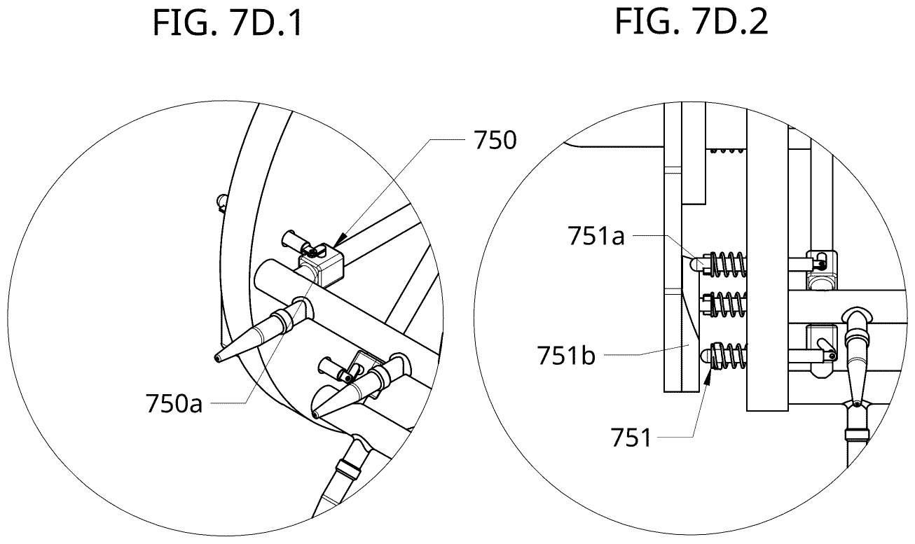

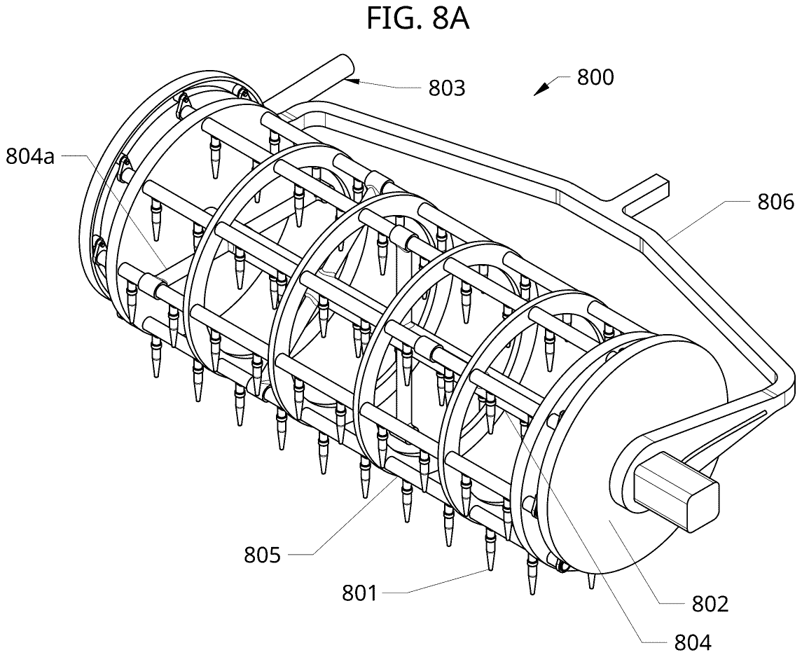

Optionally, such valving may be via solenoids, motors or otherwise. Two non-limiting examples of such valving is detailed in FIGS. 7A, 7C.1, 7C.2, 7D.1 and 7D.2. There a camming surface 751b contacts and urges cam follower 751a (see FIG. 7D.2). In such case rods 751 move laterally in and out, thereby opening a mechanical valve mechanism 750, 750a as shown if FIG. 7D.1 and 7D.2.

Optional valving is also shown in FIG. 7C.1 and 7C.2. There, the electric valve 740, 740a may be activated (opened and closed) via springs 741 urging contacts 741a into electrical contact with conductor 741b as it rotates into place (completing a circuit) and the out of place and contact (breaking the circuit) to open and close the flow as the probe or other element is in the soil. Other valving systems are possible as well.

Optionally the device may have the steam conduit(s) enter 503 along the first axis A-A (FIG. 5A) of rotation.

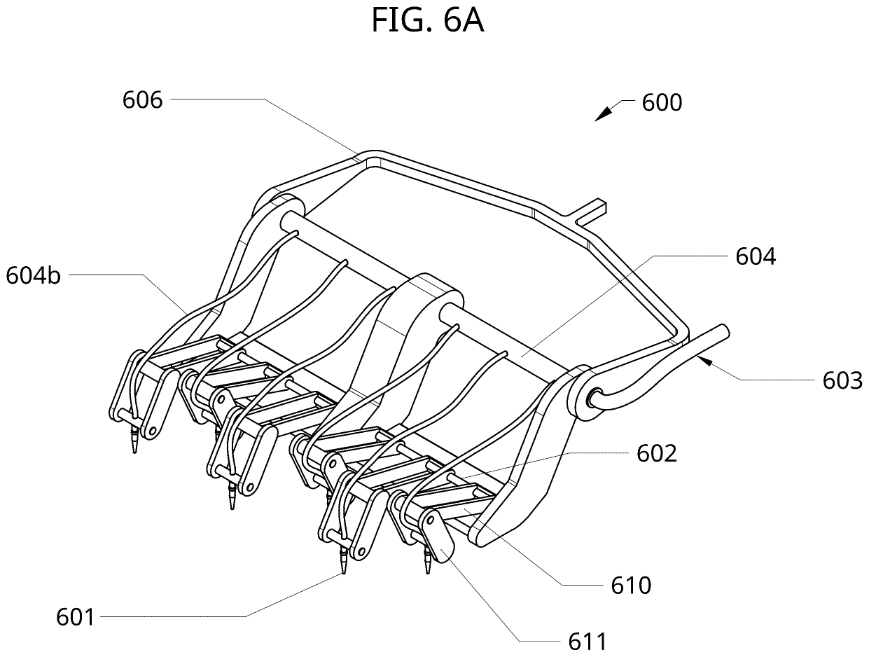

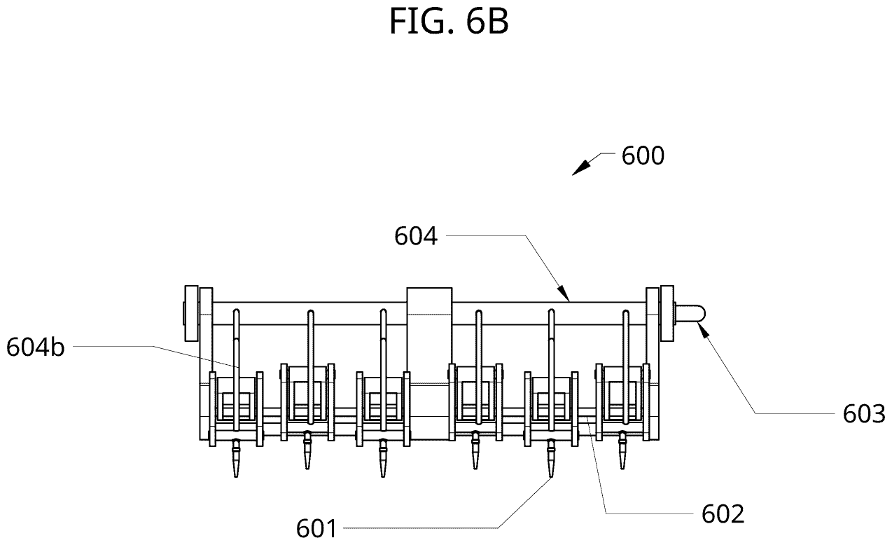

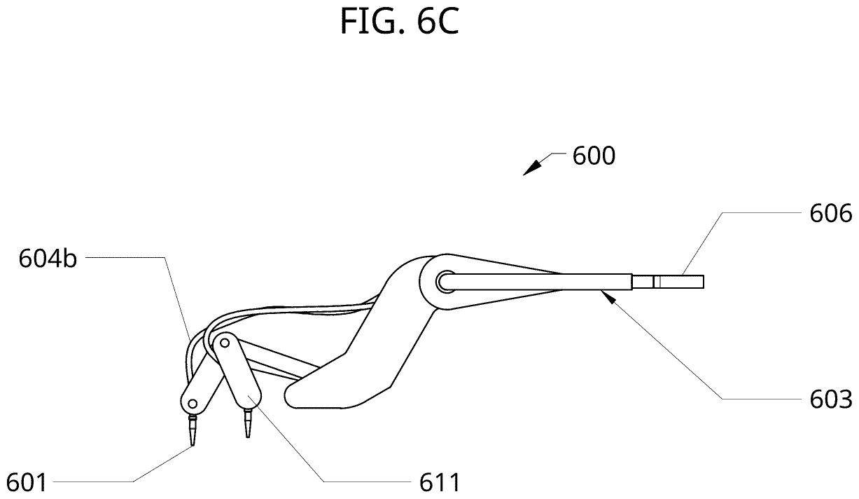

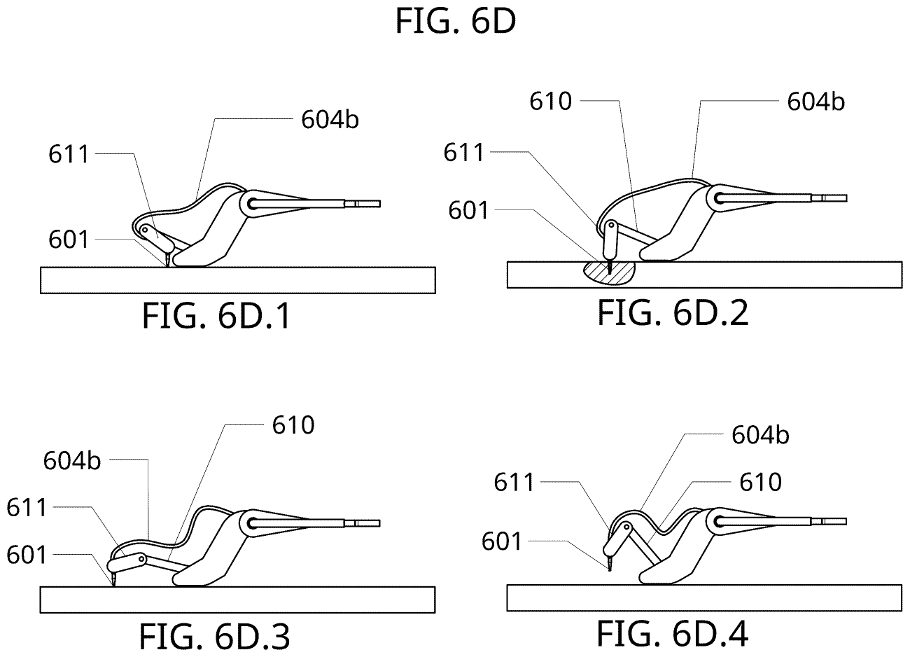

Also, optionally the device may have the rotary member comprise a crank shaft and wherein the probes are part of articulated arms that repetitively inject into the soil and then out of the soil while optionally maintaining a substantially constant angle of attack in and out of the soil. An example of this is shown in FIGS. 6A-6D (and FIG. 6d.1-6d.4 showing a progression through pre-insertion, bottom dead center, post insertion, and top dead center). The crank shaft includes articulated arms 610 and 611(hollow for steam flow to probe 601). Steam flows through conduit 603, 603 a, and 603b and 604 to probes 601. Valving is preferably provided for steam flow during insertion in the soil. This provides an angle of attack that is more vertical, preferably less than plus/minus ten degrees from vertical.

Optionally, the device rotary member 500, 800 may comprise a drum with the plurality of probes along and around the outside of the drum.

Optionally, the device 800 rotary member 802 may comprise a plurality of horizontal cross members 804 having steam conduits therein, the cross members running parallel to the first axis of rotation and rotatable on their own axis, the cross members having a plurality of the probes 801 thereon and being rotatable to have the probes face generally downwardly towards the soil field to repetitively inject into the soil and then out of the soil as the device advances in the first direction.

Optionally, as shown in perspective detail FIG. 8E on way to achieve that is with a cam follower mechanism 815 causing rotation of 815a and of conduit 804 to keep probes 801 perpendicular to the ground. Optionally, such rotation may be synchronized with steam valving.

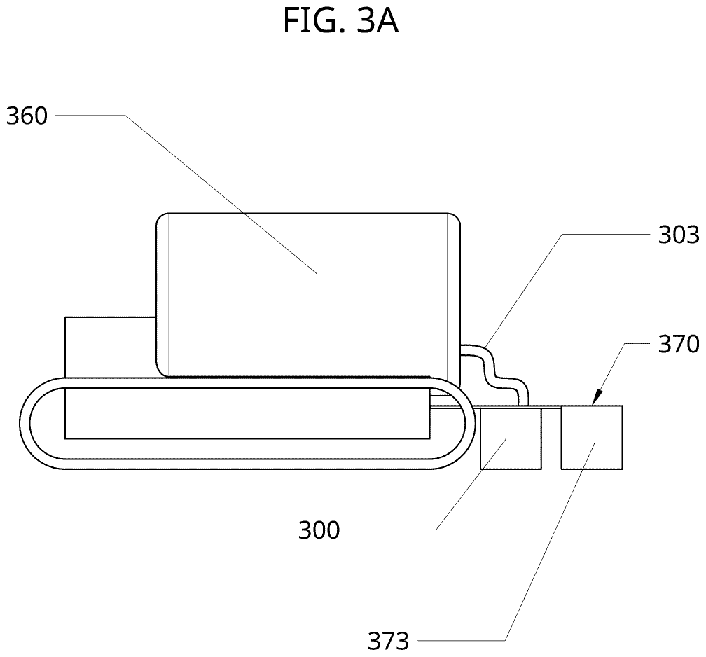

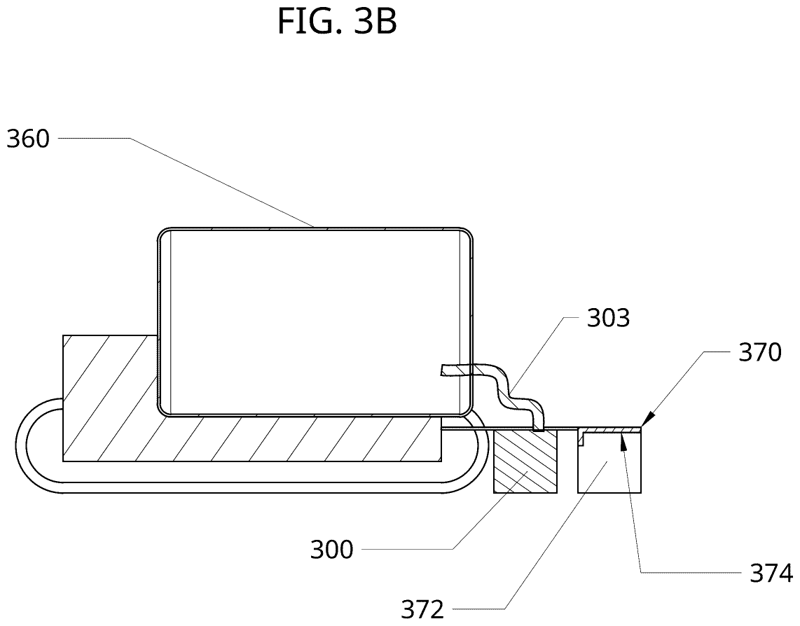

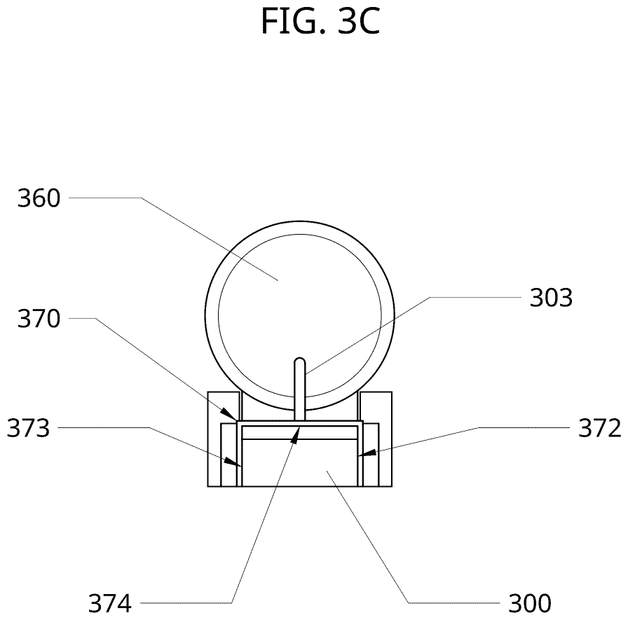

Optionally, yoke 506, 606, 706, 806 or other mechanical attachment to a tractor or other vehicle 160, 260 provides movement in the first direction along a bed B2. Such vehicle can have treads, wheels or both. Such vehicle may carry the steam source (FIGS. 2A, 2B, 3A, 3B, 3C, 4) or optionally be separate (FIGS. 1A, 1B) with a flexible conduit 103 providing the steam to the device.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

### DEFINITIONS

The language used in the present disclosure is to only have its plain and ordinary meaning, except for terms explicitly defined below. Such plain and ordinary meaning is defined here as inclusive of all consistent dictionary definitions from the most recently published (on the filing date of this document) general purpose Merriam-Webster dictionary. Claim elements are ‘means plus function’ only when “means” is expressly recited.

As used herein, the following terms have the following defined meanings:

The term “agricultural beds” here means a raised ridge or section in a agricultural field forming a planting bed for row(s) of crops or plants. It typically is raised between furrows. It may have a variety of cross-sectional shapes but preferably is rectangular or trapezoidal.

The term “angle of attack” here means the angle(s) an inserter is inserted into the soil plus or minus degrees from vertical.

The term “articulated arms” here means mechanical arms movable in a generally circular motion in a plane along the direction of device movement (typically towed behind a tractor or other vehicle) and serving to reduce or eliminate variance in the angle of attack.

The term “bed shaper” here means dragged or pushed surfaces pressing along the top and/or side(s) of generally loose soil to shape it into an agricultural bed.

The term “conduits” here means enclosed pathway for steam to flow to an inserter. This includes such within axle and inserters.

The term “crank shaft” here means mechanical parts that together convert rotary movement into reciprocating linear (or near linear) movement.

The term “drum” here means a geometry that is generally cylindrical, being generally circular in plane(s) along the direction of device movement, and generally linear in a direction perpendicular thereto (e.g. along a transverse axle or axis of rotation above a bed). However, generally cylindric includes shapes where the diameter is reduced in the middle, such as to accommodate the rectangular or trapezoidal shape of a bed. Also, drum and/or generally cylindrical includes such shaped by solid outer wall, as well as frames or cages, as well as both.

The term “furrows” here means a channel constructed along a field to carry water between crop rows, commonly used in the irrigation of row crops that require adequate moisture while allowing for drainage.

The term “probes” here means a type of inserter that is elongated and is receptively injected into and out of the soil. It has a steam conduit therethrough and/or motion steam exit openings at its distal end and/or sidewalls. It may be round, oval, rectangular or otherwise in cross-section. It may be tapered or non-tapered.

The term “repetitively inject” here means to be injected or inserted into the soil and retracted out of the soil as the device advances along a row.

The term “rotary member” here means a member that rotates as the device advances along a row.

The term “simultaneously” here means at or near the same time.

The term “soil surface” here means the surface of soil and/or between interfacing with the atmosphere.

The term “steam” here means water vapor at or about 100 degrees Celsius. It may include superheated steam. Preferably it is 100 percent water, but optionally it may include air or other chemicals including fungicides, pesticides, fertilizers, herbicides and/or weed germination inhibitors.

The term “steam exit openings” here means an opening, hole, slot, or otherwise, where steam flows into the soil.

The term “steam source” here means a device for boiling water to create steam.

The term “substantially flat surface” here means an agricultural surface sufficiently flat to safely operate a tractor without undue risk of it turning over. This typically is having a slope of less that 25%, and more preferably less than 15%, and which complies with applicable laws for a given area.

The term “valving” here means mechanically moving blockers (ball valves, gate valves, baffles, solenoid, pneumatic and otherwise) that block or substantially restrict the flow of steam. Normally, such blocking is when the inserter and/or probe is above the soil surface.

What is claimed is:

1. A device for preparing agricultural planting beds, comprising:
A bed shaper comprising a left surface, a right surface and a top surface inboard of the left and right surfaces and collectively defining a rear-elevation profile adapted for shaping a soil bed above and between furrows outside the left and right surfaces as the bed shaper is advanced in a soil field a first direction;
A steam delivery system adapted to be connected to a steam source;
The steam delivery system comprising one or more conduits to deliver steam from the steam source to a plurality of steam exit openings,
The steam exit openings being positioned below the soil surface for steam delivery into the soil,
The steam exit openings being positioned ahead of at least a portion of said bed shaper.

2. The device of claim 1 and comprising a bar dragged below the soil and ahead of at least a portion of said bed shaper.

3. The device of claim 1 and comprising a plurality of probes having the steam exit openings inserted below the soil surface.

4. The device of claim 1 and comprising a rotary member rotating about a first axis of rotation that is generally horizontal and generally perpendicular to the first direction, the rotary member causing probes having the steam exit openings to repetitively inject into the soil and then out of the soil as the device advances in the first direction.

5. The device of claim 1 and wherein the steam conduit enters along the first axis of rotation.

6. The device of claim 1 and wherein the rotary member comprises a crank shaft and wherein the probes are part of articulated arms that repetitively inject into the soil and then out of the soil while maintaining a substantially constant angle of attack in and out of the soil.

7. The device of claim 1 and wherein the rotary member comprises a drum with the plurality of probes along and around the outside of the drum.

8. The device of claim 1 and wherein the rotary member comprises a plurality of horizontal cross members having steam conduits therein, the cross members running parallel to the first axis of rotation and rotatable on their own axis, the cross members having a plurality of the probes thereon and being rotatable to have the probes face generally downwardly towards the soil field to repetitively inject into the soil and then out of the soil as the device advances in the first direction.

9. A device for preparing agricultural planting beds, comprising:
A steam delivery system adapted to be connected to a steam source;
The steam delivery system comprising one or more conduits to deliver steam from the steam source to a plurality of steam exit openings,
The steam exit openings being positionable below the soil surface for steam delivery into the soil,
A rotary member rotating about a first axis of rotation that is generally horizontal and generally perpendicular to the first direction, the rotary member causing probes having the steam exit openings to repetitively inject into the soil and then out of the soil as the device advances in the first direction.

10. The device of claim 9 and wherein the steam conduit enters along the first axis of rotation.

11. The device of claim 9 and wherein the rotary member comprises a crank shaft and wherein the probes are part of articulated arms that repetitively inject into the soil and then out of the soil while maintaining a substantially constant angle of attack in and out of the soil.

12. The device of claim 9 and wherein the rotary member comprises a drum with the plurality of probes along and around the outside of the drum.

13. The device of claim 9 and wherein the rotary member comprises a plurality of horizontal cross members having steam conduits therein, the cross members running parallel to the first axis of rotation and rotatable on their own axis, the cross members having a plurality of the probes thereon and being rotatable to have the probes face generally downwardly towards the soil field to repetitively inject into the soil and then out of the soil as the device advances in the first direction.

14. The device of claim 9 and wherein including valving to open steam flow to the probes when they are injected in the soil and to close steam flow to the probes when they are out of the soil.

15. A method of preparing for planting crops, comprising the acts of:
tilling a soil field into a substantially flat surface;
thereafter pulling a device in the field that has a steam inserter below the surface of the soil;
pulling a bed shaper at least partially behind said steam inserter that shapes the substantially flat soil into soil beds between furrows.

16. The method of claim 15 and further comprising the act of pulling an inserter which includes a transverse bar having a plurality of steam exit openings below the surface of the soil.

17. The method of claim 15 and further comprising the act of pulling a plurality of probes collectively having a plurality of steam exit openings repetitively injected below the surface of the soil in response to rotation.

18. The method of claim 15 and further comprising the act of thereafter planting crops in the bed.

19. The method of claim 15 wherein said pulling the steam inserter and the pulling of said shaper occur simultaneously behind a vehicle.

20. The method of claim 19 and further comprising the act of thereafter planting crops in the bed.

21. A method of preparing for planting crops, comprising the acts of:
tilling a soil field;
thereafter pulling a bed shaper that shapes the soil into soil beds between furrows;
thereafter pulling a steamer having probes to insert into the bed to inject steam into the bed.

22. The method of claim 21 wherein said inserting into the bed is only at targeted locations in the bed and thereafter planting agricultural crops at said targeted locations.
